(19) United States
(12) Patent Application Publication
(10) Pub. No.: US 2013/0180813 A1
(43) Pub. Date: Jul. 18, 2013

(54) FLUID-FILLED SHOCK ABSORBER

(71) Applicant: Eustace Moore, JR., Covina, CA (US)

(72) Inventor: Eustace Moore, JR., Covina, CA (US)

(21) Appl. No.: 13/349,741

(22) Filed: Jan. 13, 2012

(51) Int. Cl. F16F 9/516; B60G 13/06; F16F 9/18

(52) U.S. Cl. 188/282.6

(57) ABSTRACT

A shock absorber configured to mount within a remote control vehicle. The shock absorber includes a cylindrical housing, a piston rod, and an acircular piston head. The piston head includes a plurality of substantially flat surfaces disposed on sides of the piston head that form bypass gaps between the piston head and the cylindrical housing. The acircular piston head includes a plurality of bypass apertures disposed through the piston head in an angularly asymmetrical configuration. The acircular piston head is generally octagon shaped. The acircular piston head includes a plurality of spaced arcuate edges sized to come in contact with an interior surface of the cylindrical housing. The shock absorber includes a plurality of bypass valves formed by cooperative operation of a shim coupled against the bypass apertures, such that fluid is permitted to flow through the bypass valves in a first direction and is restricted in a second direction.

### BACKGROUND OF THE INVENTION

### 1. Field of the Invention

The present invention relates to shock absorbers, specifically fluid-filled shock absorbers that may be used for remote controlled vehicles.

2. Description of the Related Art

A shock absorber is a mechanical device designed to smooth out or damp shock impulse, and dissipate kinetic energy. The shock absorber is configured to absorb or dissipate energy. Shock absorbers help cushion vehicles on uneven roads. In a vehicle, shock absorbers reduce the effect of traveling over rough ground, leading to improved ride quality and increase in comfort. While shock absorbers serve the purpose of limiting excessive suspension movement, their intended sole purpose is to dampen spring oscillations.

Shock absorbers use valving of oil and gasses to absorb excess energy from the springs. One type of shock absorber is a fluid friction shock absorber, where fluid flows through a narrow orifice (hydraulics). This type constitutes the vast majority of automotive shock absorbers. An advantage of this type is that using special internal valving the absorber may be made relatively soft to compression (allowing a soft response to a bump) and relatively stiff to extension, controlling “rebound”, which is the vehicle response to energy stored in the springs; similarly, a series of valves controlled by springs can change the degree of stiffness according to the velocity of the impact or rebound. Specialized shock absorbers for racing purposes may allow the front end of a dragster to rise with minimal resistance under acceleration, then strongly resist letting it settle, thereby maintaining a desirable rearward weight distribution for enhanced traction. Some shock absorbers allow tuning of the ride via control of the valve by a manual adjustment provided at the shock absorber.

Shock absorbers are also used in other settings, including on remote control (RC) vehicles. RC racing is a highly competitive sport and small advantages in performance can make huge differences in performance on the field. High performing shock absorbers permit better handling, acceleration and permit driving at higher speeds on courses. However, because of the huge differences in scale between regular automotive vehicles and RC vehicles, it is rare that functional improvements in one area can translate directly to identical structure in another area. Accordingly, the similar needs between the settings are often met by structure that is different. It is common for a solution to a problem in one setting to be substantially ineffectual in the other when scaled because of differences in material strengths, relative distances, experienced forces, track environments, and the like. This is further compounded by inconsistencies in relating parts between the diverse settings.

Some improvements have been made in the field. Examples of references related to the present invention are described below in their own words, and the supporting teachings of each reference are incorporated by reference herein:

U.S. Pat. No. 7,628,259, issued to Norgaard et al., discloses shock absorber components, such as a radial bypass damper, an anti-cavitation valve (ACV) and an incremental flow metering valve IFMV. The damper is of a continuous, unitary construction with a main hole and auxiliary holes interconnected by passageways. The ACV has openings that angle obliquely relative to entry surfaces of valving shims and extend at an incline continuously through the valving shims. The metering valve linearly regulates flow, substantially independent of piston displacement.

U.S. Pat. No. 7,559,272, issued to Nakagawa, discloses a cylinder apparatus includes a cylinder and a rod contractibly extending from the cylinder. A cylindrical protecting cover is secured to the rod to cover the rod and the cylinder. The rod has a plate-shaped head cap secured thereto. The protecting cover is provided with clamp portions that axially clamp the outer peripheral portion of the head cap. The head cap is provided with circumferentially spaced projections projecting toward the cylinder, so that the axial dimension over which the head cap is clamped by the clamp portions is larger than the plate thickness of the head cap.

U.S. Pat. No. 7,270,222, issued to Aymar, discloses a shock absorber that combines both the suspension function and the shock absorbing function in one unit. It has an elongated shock body filled with hydraulic fluid and a piston mounted on a piston rod that reciprocally travels within the shock body. The shock body is telescopically received in a bypass cylinder body having a greater diameter that produces an annular chamber between the outer surface of the shock body and the inner surface of the bypass cylinder body. A coil spring is mounted on the outside surface of the bypass cylinder body to provide a suspension function by the shock absorber. A plurality of bypass tubes are associated with longitudinally spaced ports in the shock body. Adjuster rods are telescopically received inside the respective bypass tubes for controlling whether the individual ports are closed, partially open, or fully open. These adjuster rods would be manipulated externally of the shock absorber assembly.

U.S. Pat. No. 6,244,398, issued to Girvin et al., discloses a dampener for a shock absorber of a vehicle, such as a bicycle, is mounted within a telescoping front fork including a stanchion tube and a coaxial slide tube. The dampener includes an internally received hydraulic fluid sleeve that defines a hydraulic chamber in which a piston assembly is disposed. Movement of the piston assembly through hydraulic fluid within the hydraulic chamber is selectively adjusted by metering the flow of bypass hydraulic fluid to the back side of the piston assembly by adjusting a fluid bypass assembly disposed longitudinally within the stanchion tube. The responsive valve assembly includes outlet and inlet ports, and biased bypass valves that move between open and closed positions. In response to sensed velocity and/or displacement of the piston assembly, thereby adjusting the damping of the shock absorber.

The inventions heretofore known suffer from a number of disadvantages which include being limited in use, being limited in adjustability, being difficult to use, being limited in dampening, being unable to be adapted for use with RC vehicles, requiring extensive reconditioning or retooling of existing parts/practices, failing to stop/reduce hydraulic locking, failing to stop/reduce hydraulic locking in an RC vehicle, and the like and combinations thereof.

What is needed is a shock absorber that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available shock absorbers. Accordingly, the present invention has been developed to provide a shock absorber that does not lock up during use.

According to one embodiment of the invention, there is a fluid-filled shock absorber that may be configured to mount within a remote control vehicle. The shock absorber may include a cylindrical housing that may be configured to store a fluid therein. The cylindrical housing may include a top aperture. The shock absorber may include a piston rod that may have an upper mounting structure. The upper mounting structure may be configured to extend through the top aperture of the housing and couple to a mounting bracket of a remote control vehicle.

The shock absorber may include an acircular piston head that may be coupled to an end of the piston rod and may be disposed within the cylindrical housing. The acircular piston head may include a plurality of substantially flat surfaces that may be disposed on sides of the piston head that may form bypass gaps between the piston head and the cylindrical housing. The acircular piston head may include a plurality of bypass apertures/valves that may be disposed through the piston head in an angularly asymmetrical configuration. The plurality of bypass apertures/valves may be disposed in a mirrored configuration. The acircular piston head may be generally octagon shaped. The acircular piston head may include a plurality of spaced arcuate edges that may be sized to come in contact with an interior surface of the cylindrical housing.

The shock absorber may include a plurality of bypass valves that may be formed by cooperative operation of a shim, that may be coupled against bypass apertures, such that fluid may be permitted to flow through the bypass valves in a first direction and may be restricted in a second direction; there may be a radial fulcrum member braced against a shim opposite the piston head such that the shim bends against the radial fulcrum member when fluid flows across the shim; the shim may fold about a single fold axis when flow is permitted because of radial asymmetry of the bypass apertures/valves. The color of a shim may correspond to a performance characteristic of the shim. The color of a shim may correspond to a thickness of the shim according to a color coding schema. The shock absorber may further include a stop-washer (and/or radial fulcrum member) that may be coupled against the shim, opposite the piston head, and may include a flange that may be extending outwardly therefrom that may partially restrict bending of the shim by acting as a fulcrum during bending of the same.

According to one embodiment of the invention, there is an octagon-shaped piston head that may be coupled to an end of a piston rod and may be disposed within a cylindrical housing of a shock absorber. The piston head may include a plurality of substantially flat surfaces that may be disposed on sides of the piston head that may form bypass gaps between the piston head and a cylindrical housing. The piston head may include a plurality of bypass valves that may be disposed therethrough.

The octagon-shaped piston head may include a plurality of bypass apertures that may be formed by cooperative operation of a shim, coupled against the bypass apertures, such that fluid may be permitted to flow through the bypass valves in a first direction and restricted in a second direction; and wherein the shim folds about a single fold axis when flow may be permitted because of the radial asymmetry of the bypass valves. The plurality of bypass valves may be disposed in a mirrored configuration. The color of a shim may correspond to a performance characteristic of the shim. The color of a shim may correspond to a thickness of the shim according to a color coding schema.

The octagon-shaped piston head may further include a stop-washer that may be coupled against the shim, opposite the piston head, and may include a flange that may be extending outwardly therefrom that may partially restricts bending of the shim by acting as a fulcrum during bending of the same.

According to one embodiment of the invention, there is a shock absorber that may include a plurality of bypass apertures that may be disposed about a piston head. The bypass apertures may be formed by cooperative operation of a shim, that may be coupled against a plurality of bypass valves, that may be disposed about the piston head in a radial asymmetric pattern, such that fluid may be permitted to flow through the bypass valves in a first direction and may be restricted in a second direction; and wherein the shim may fold about a single fold axis when flow is permitted because of the radial asymmetry of the bypass valves.

The shock absorber may further include a stop-washer that may be coupled against the shim opposite the piston head and may include a flange that may be extending outwardly therefrom that may partially restrict bending of the shim by acting as a fulcrum during bending of the same. The color of a shim may correspond to a performance characteristic of the shim. The color of a shim may correspond to a thickness of the shim according to a color coding schema.

The shock absorber may also include an acircular piston head that may be coupled to an end of a piston rod and may be disposed within a cylindrical housing. The acircular piston head may include a plurality of substantially flat surfaces that may be disposed on sides of the piston head, that may form bypass gaps between the piston head and the cylindrical housing. The acircular piston head may include a plurality of bypass valves that may be disposed through the piston head in an angularly asymmetrical configuration. The plurality of bypass valves may be disposed in a mirrored configuration.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 illustrates a partial side cross-sectional view of a shock absorber, according to one embodiment of the invention;

FIG. 2 illustrates an exploded perspective view of a piston head, shim and washer of a shock absorber, according to one embodiment of the invention;

FIG. 3 illustrates a front perspective view of a piston head, shim, and washer coupled together, of a shock absorber, according to one embodiment of the invention;

FIG. 4 illustrates a back perspective view of a piston head, shim, and washer coupled together, of a shock absorber, according to one embodiment of the invention;

FIG. 5 illustrates an exploded perspective view of a piston head, shim and washer of a shock absorber, according to one embodiment of the invention;

FIG. 6 illustrates a front perspective view of a piston head, shim, and washer coupled together, of a shock absorber, according to one embodiment of the invention;

FIG. 7 illustrates a back perspective view of a piston head, shim, and washer coupled together, of a shock absorber, according to one embodiment of the invention;

FIG. 8 illustrates a back perspective view of an acircular piston head assembly and shaft of a shock absorber, according to one embodiment of the invention;

FIG. 9 illustrates a front perspective view of a acircular piston head assembly and shaft of a shock absorber, according to one embodiment of the invention;

FIG. 10 illustrates a back perspective view of a piston head assembly and shaft of a shock absorber, according to one embodiment of the invention;

FIG. 11 illustrates a front perspective view of a piston head assembly and shaft of a shock absorber, according to one embodiment of the invention; and

FIG. 12 illustrates a cross-sectional view of a portion of the piston head assembly illustrated in FIG. 11.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

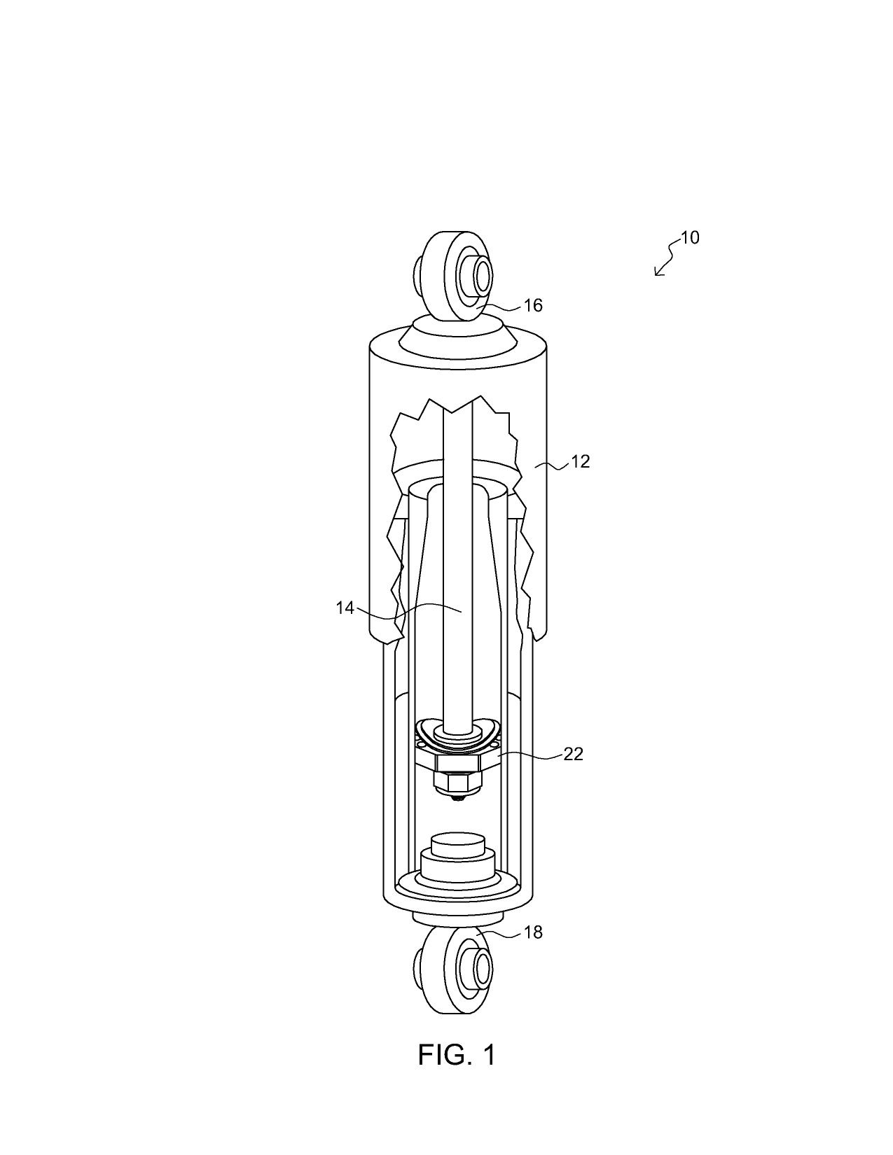

FIG. 1 illustrates a perspective view of a shock absorber, according to one embodiment of the invention. There is shown a shock absorber 10 including a cylindrical housing 12, a piston rod 14 extending through the cylindrical housing 12, an upper mounting structure 16 coupled to the piston rod 14, and a lower mounting structure 18 coupled to an opposite end of the cylindrical housing 12, relative to the upper mounting structure 16. A piston head assembly 22 is coupled to an end of the piston rod 14 and is disposed in a hydraulic fluid contained within the piston cavity. The illustrated piston head assembly 22 is traveling in a forward direction such that flow of the hydraulic fluid (generally oil-based) within the cavity is flowing from front to back and thereby causing deformation of a portion of the piston head assembly, namely shims disposed at a rear surface of the piston head assembly are deformed into a U or “taco” shaped structure as opposed to a flat resting shape when not deformed.

The illustrated fluid-filled shock absorber 10 is configured to mount within a remote control vehicle, such as but not limited to a radio controlled (or otherwise remotely controlled such as but not limited to by wire, infrared, microwave, magnetic induction, laser communication, and the like and combinations thereof) car, truck, boat, plane, buggy, tank, helicopter, blimp or the like or combinations thereof. A radio controlled vehicle is generally much smaller than a standard vehicle of its type, often ⅛ 1/10 or 1/12 to scale, while maintaining proportionally high speeds and enduring difficult road conditions during racing and other use. This difference in sizing causes typical hydraulic shock structures that are used in normal sized vehicles to underperform and to be impossible to properly tune to RC car implementations. Generally, such shocks, when merely scaled down tend to be too loose or too stiff in their compression and/or rebound responses and tend to have a poor range for tuning the same.

Accordingly, typical RC car shocks experience lock-up under certain conditions wherein the shock locks in position in response to delivered forces and cannot deliver appropriate performance on successive experiences of force (bumps, landings, and etc.). In particular, it is believed that hydraulic locking occurs when the piston speed exceeds the capabilities of the orifices and locks the piston movement. The illustrated shock absorber and others illustrated herein resolve that issue and provide varied dampening and bypass while eliminating hydraulic locking. Advantageously, this provides more consistent and tunable performance by converting standard shocks into variable valved bypass shocks. Further, such structure may generally be implemented by only replacing the piston head assembly, while leaving all other parts the same and not taking up any additional exterior space. Accordingly, the solution may be easily implemented in existing vehicles without need for major retrofitting or revamping of design.

The illustrated shock absorber 10 includes a composite cylindrical housing 12 that is configured to store a fluid within the inner housing portion, wherein is disposed the piston head assembly 22. The cylindrical housing 12 includes a top aperture and a piston rod 14 extending therethrough. The piston rod 14 includes an upper mounting structure coupled to an end thereof and may be configured to couple to a mounting bracket of a remote control vehicle. The cylindrical housing 12 includes a lower mounting structure disposed on an end of the cylindrical housing 12, opposite of the upper mounting structure 16, and may be configured to mount to a mounting bracket of a remote control vehicle. The upper mounting structure and the lower mounting structure are coupled to the mounting brackets by a coupling device, such as but not limited to, bolts, nuts and washers and the like and combinations thereof.

In operation of one non-limiting embodiment of the invention, the fluid filled shock absorber is mounted to a remote control vehicle. The upper mounting structure and lower mounting structures are coupled to a pair of mounting brackets disposed within a wheel well of a remote control vehicle. The fluid filled shock absorber is configured to reduce the effect of traveling over rough ground, thereby providing an enhanced ride quality and limiting excessive suspension movement. This results in better speed, acceleration, handling and fuel efficiency.

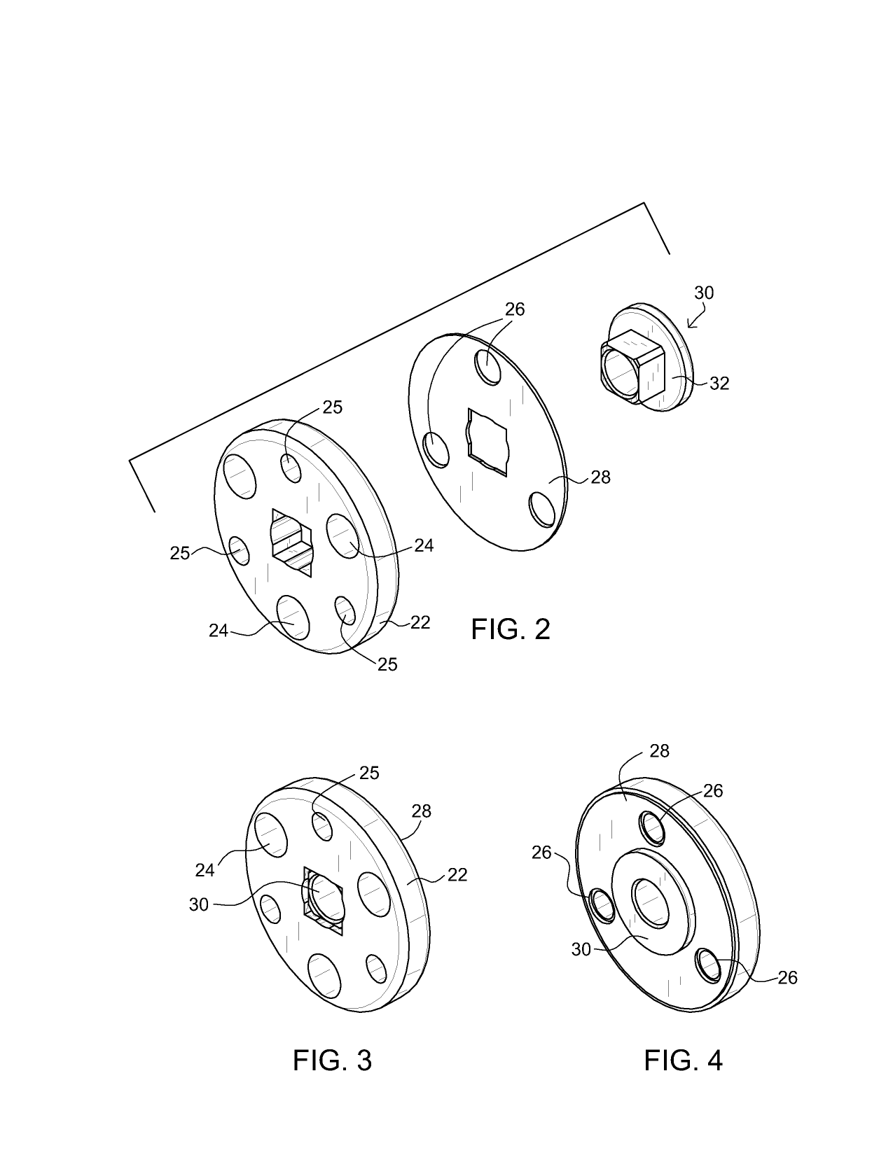

FIGS. 2-4 illustrates an exploded perspective view of a piston head, shim and washer/radial fulcrum member of a shock absorber, and front and back non-exploded views of the same, according to one embodiment of the invention. There is shown a circular piston head 22 including a plurality of bypass valve apertures (bypass apertures that are covered by a shim in operation) 24 disposed through the piston head 22, a plurality of bypass apertures 25 disposed through the piston head 22, a shim 28 having a plurality of bypass apertures 26, and a stop-washer 30. The shim 28 is sandwiched and pinned between the piston head 22 and the stop-washer 30 and positioned such that the bypass apertures 26 of the shim are aligned with the bypass apertures 22 of the piston head and the shim is covering the bypass valve apertures 24 of the piston head. Accordingly, fluid may freely flow through the bypass apertures 25 and 26 in either direction, but are asymmetrically restricted in flow through the bypass valve apertures 24 because the bypass valve apertures 24 in cooperation with the pinned, but flexible, shim 28 form a plurality of bypass valves.

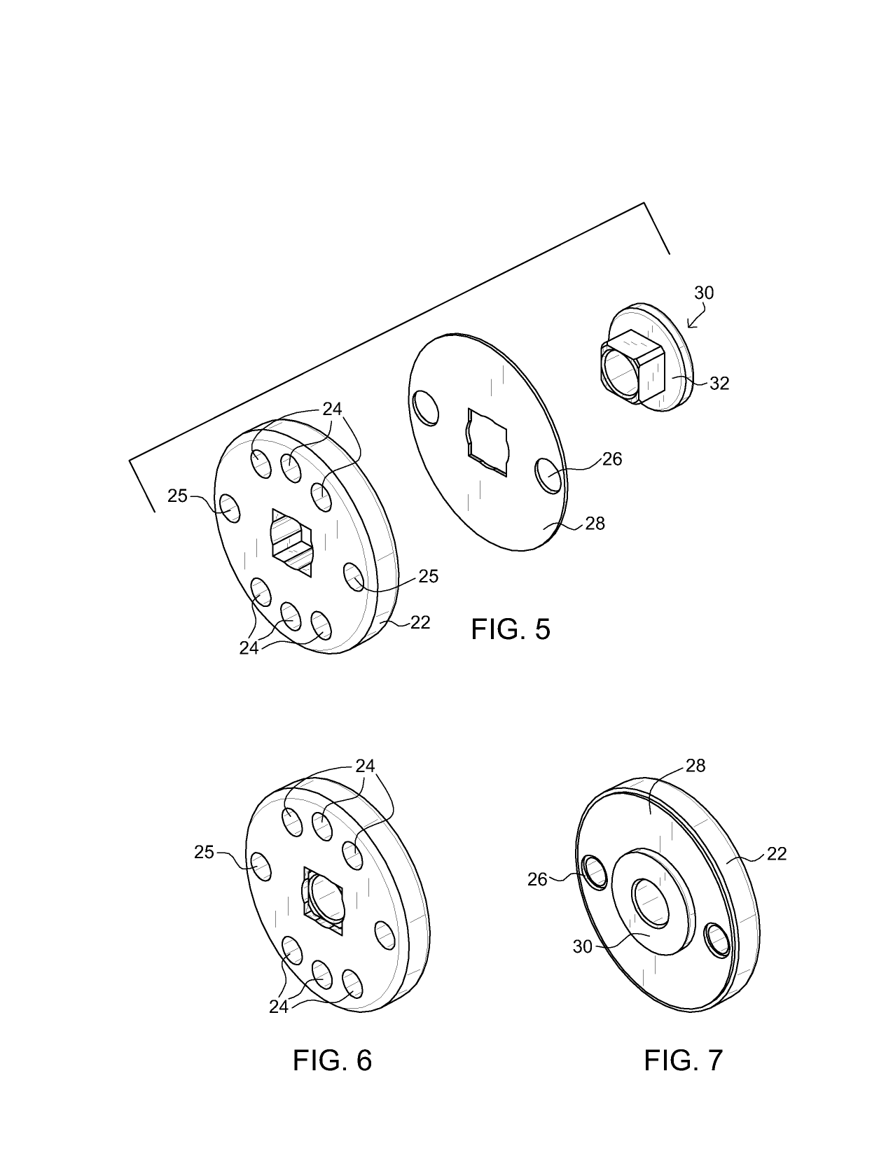

The illustrated circular piston head 22 is configured to couple to an end of a piston rod of a shock absorber. The circular piston head 22 includes a plurality of bypass valve apertures 24 disposed through the piston head 22. The illustrated arrangement of bypass valve apertures 24 are in an angularly symmetric configuration. In particular, there are more than two bypass valve apertures and angularly adjacent bypass valve apertures are equidistant from each other. Accordingly, force applied through the bypass valve apertures distributes that same force substantially equally about the shim, thereby causing he shim to crumple instead of fold. This causes a substantially different force response to folding, thereby creating a different tuning curve and response range. Where such is not the case, the bypass valve apertures, and thus the bypass valves thereby formed, would be angularly asymmetric (as an example, see FIG. 5) and thereby cause a folding of the shim generally about a single axis during a compression stroke. The sizes of the bypass valve apertures contributes to the performance characteristics of the shock through its interaction with the shims. In particular, larger bypass valve apertures permit greater fluid flow therethrough and also alter how force is applied to the shim. The distance from the center of the piston head of the bypass valve aperture also influences the valve characteristics and therefore the performance characteristics of the shock because of the leveraging effect such has on the flexing shim.

The illustrated piston head 22 includes a plurality of bypass valves that are formed by cooperative operation of a shim 28 that is coupled against the bypass valve apertures (bypass apertures) 24 and braced against a radial fulcrum member (illustrated as a stop-washer) 30, such that fluid is permitted to flow through the bypass valve apertures 24 in a first direction and is restricted in a second direction. The arrangement creates fluid flows that deflect and pivot the shims from a fulcrum that takes advantage of material strengths and other characteristics of the shims such that the shim, in cooperation with the bypass valve apertures of the piston head, act as a plurality of valves. The piston head is generally precision machined from bearing grade plastics.

The illustrated stop-washer 30 is coupled against the shim 28, opposite the piston head 22, and pinning the shim 28 thereto about a center region thereof. The stop-washer includes a flange 32 extending outwardly therefrom that partially restricts bending of the shim by acting as a fulcrum during bending of the same. The radius of the flange 32 influences the force response of the shim 28. In particular, a wider radius flange results in a stiffer shim and a narrower radius flange results in a shim that flexes more in response to force. Accordingly, a user may simply swap out a stop-washer of a particular size for another and alter a performance characteristic of a shock. In operation, the flange radius, in combination with the selected shim(s) determines the effective valve flex modulus, which is directly related to the force response curve. The flange also improves reliability and durability of the valve/shim(s) and sets/helps set the dampening and bypass rates. A stop washer may be flat and/or may include a raised boss.

The illustrated shim 28 may be comprised of materials with varying properties, including strength, flexibility, durability, elasticity, resistance to chemicals, and the like and combinations thereof. Generally the shim is a flat disc of elastically flexible material that has a resting shape that is flat. Further, such shims may be configured to different shapes/sizes including but not limited to thickness, inner radius, outer radius, graduating thicknesses (angularly, axially, and/or otherwise), and the like and combinations thereof. Accordingly, shims may be created having a great variety of force response curves and a multitude of other characteristics, thereby enabling a user to modify a compression and/or rebound stroke of a shock absorber by using one or more shims alone or in conjunction with other customized shims. Shims are generally stamped during manufacture to ensure flatness and therefore consistent performance.

The following are non-limiting examples of available shim colors and corresponding sizes, by Professional Plastics, Inc. at 1810 E. Valencia Drive, Fullerton, Calif., 92831. Material Type Practi-Shim #222 may include a 0.0005″ Silver Practi-Shim, a 0.00075″ Gold Practi-Shim, a 0.001″ Amber Practi-Shim, a 0.00125″ Blue Practi-Shim, a 0.0015″ Purple Practi-Shim, a 0.002″ Red Practi-Shim, a 0.003″ Green Practi-Shim, a 0.004″ Tan Practi-Shim, a 0.005″ Blue Practi-Shim, a 0.006″ Clear Practi-Shim, a 0.0075″ Transmatte Practi-Shim, a 0.008″ Tint Blue Practi-Shim, a 0.010″ Brown Practi-Shim, a 0.012″ Black Practi-Shim, a 0.014″ Natural Practi-Shim, and a 0.015″ Pink Practi-Shim. Material Type Practi-Shim #333 may include a 0.025″ White Practi-Shim, a 0.030″ Coral Practi-Shim, a 0.040″ Black Practi-Shim, a 0.050″ Grey Practi-Shim, and a 0.060″ Cream Practi-Shim.

The following are non-limiting examples of available shim properties, by Professional Plastics, Inc. at 1810 E. Valencia Drive, Fullerton, Calif., 92831. Material Type Practi-Shim #222 may include a physical property of thickness tolerance of +/−5%, an upper service temperature of 302° F. (150° C.), a lower service temperature of −94° F. (−70° C.), a melt point of 491° F. (255° C.), a water absorption of 0.80%, an ultimate elongation 120%, a tensile at yield of 170 Mpa, a compression at 500 psi 0.11%, a density 1.39 g/cm̂3, an ignition temperature 752° F. (400° C.), and a creep of 0.90%. Material Type Practi-Shim #222 may include an electrical property of a dielectric strength 280 kV/mm, a volume resistivity 1×10̂13 cm, and a surface resistivity of 1×10̂16 cm. Material Type Practi-Shim #222 may include a chemical property suitable for Acetic acid, hydrochloric acid 10%, sodium hydroxide 10%, water, tricoethlene, detergent oils 50° F. (10° C.) and other hydrocarbon oils. Material Type Practi-Shim #222 may include a chemical property not suitable for Detergent Oils 194° F. (90° C.) and ammonium hydroxide.

The following are non-limiting examples of available shim properties, by Professional Plastics, Inc. at 1810 E. Valencia Drive, Fullerton, Calif., 92831. Material Type Practi-Shim #333 may include a physical property of thickness tolerance of +/−10%, an upper service temperature of 212° F. (100° C.), a lower service temperature of −76° F. (−60° C.), a melt point of 302° F. (150° C.), a water absorption of 0.20%, an ultimate elongation 110%, a tensile at yield of 600 kg/cm, a compression at 500 psi 1%, a density 0.91 g/cm̂3, an ignition temperature 572° F. (300° C.), and a creep of 4%. Material Type Practi-Shim #333 may include an electrical property of a dielectric strength 400V/mm, and a volume resistivity 1×10̂14 cm. Material Type Practi-Shim #333 may include a chemical property suitable for Acetic acid, hydrochloric acid 10%, sodium hydroxide 10%, water, detergent oils 50° F. (10° C.) and Detergent Oils 194° F. (90° C.). Material type Practi-Shim #333 may include a chemical property not suitable for tricoethlene, other hydrocarbons, and ammonium hydroxide.

In one non-limiting embodiment, there may be one or more shims that may be color coded. Such may be within a kit that may include one or more of the following: one or more color coded shims; a color coding schema indicator (such as but not limited to an index card electronic file, sheet of paper, layer of printed material, and the like and combinations thereof) that may provide an index or other instruction regarding interpretation of the color coding schema of the color coded shims; one or more stop-washers of varying sizes that may also be color coded; one or more piston heads of varying shapes, sizes and/or configurations; one or more guides regarding installation and/or selecting combinations of components; one or more tools, sensors and/or measurement devices useful in the selection, installation, utilization, replacement, correction, or diagnosing of issues with one or more of the components included therewith; and the like and combinations thereof. Non-limiting examples of color-coding include associating higher frequency (bluish) visible spectrum colors with, for example, stiffer shims and lower frequency (reddish) visible spectrum colors with, for example, more flexible shims; providing color coded bands (or other patterns) similar to those found on resistors and other electronic components wherein particular band patterns equal particular numbers that may be associated with one or more characteristics of a shim; color coding one or more portions of a shim including but not limited to a first side, a second side and/or a rim such that a color associated with a location indicates a particular characteristic; and the like and combinations thereof.

FIGS. 5-7 illustrates an exploded perspective view of a piston head, shim and washer of a shock absorber and front and back perspective views of the same coupled together, according to one embodiment of the invention. Structure is similar to that described in FIGS. 2-4 except that the bypass valve apertures 24, and therefore the bypass valves themselves, are distributed in an asymmetric pattern about the piston head 22. In particular, while the apertures 24 are distributed symmetrically about a line cast between the sets of three, the apertures are not symmetrically distributed angularly. The illustrated apertures 24 are distributed generally in two groups of three apertures each that are angularly spaced approximately 180 degrees apart from each other. Therefore, where large (relative to other gaps in the structure) angular gaps exist between adjacent apertures, fold lines are likely to occur. Wherein there is substantial angular asymmetry between apertures, a single dominant fold line occurs (which may be a straight fold or may be curved/angular) which induces more predictable valve behavior that is easier to tune.

Accordingly, the illustrated valves, in operation, cause flexing of the shim 28 about a single fold line instead of causing a crumpling about several fold lines. It is believed that this structure advantageously promotes a more predictable performance characteristic in small vehicles and increases the lifespan of the valve.

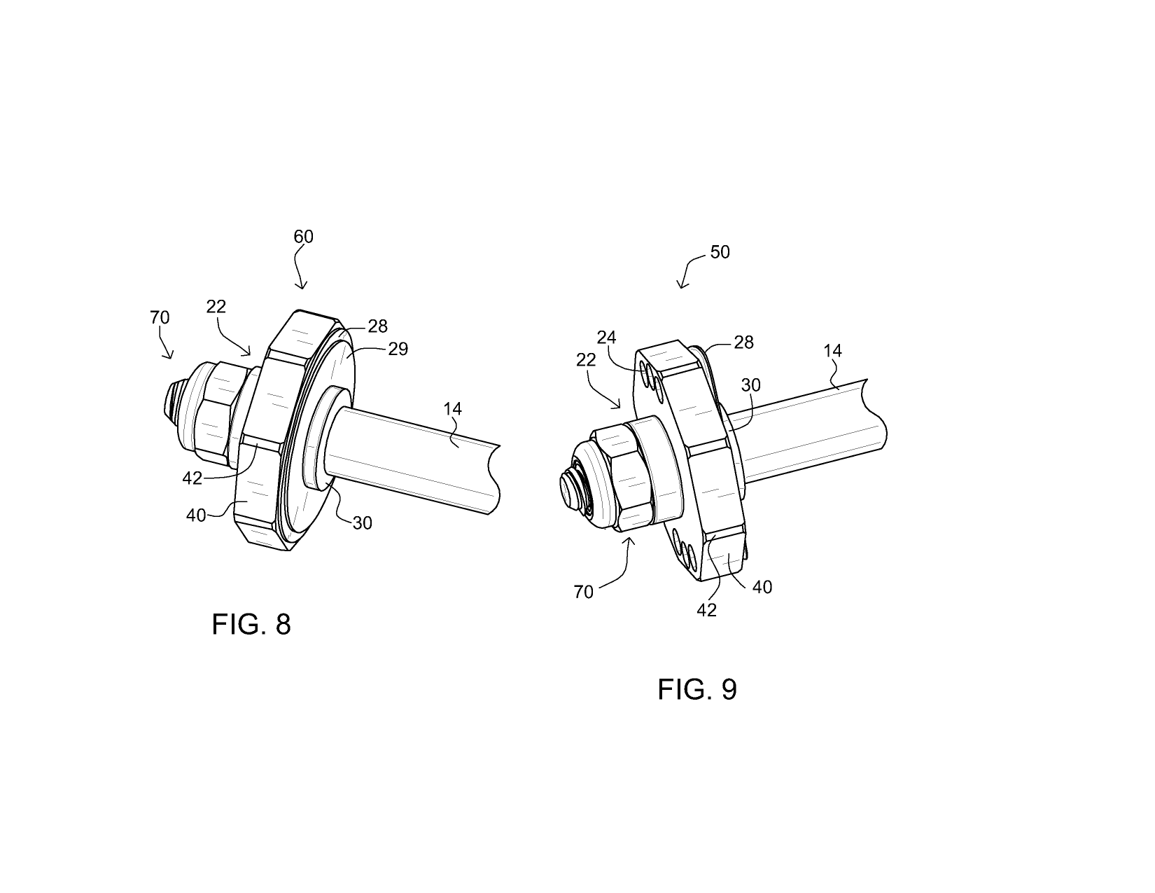

FIGS. 8 and 9 illustrate back and front perspective view of an acircular piston head assembly and shaft of a shock absorber, respectively, according to one embodiment of the invention. There is shown a shaft 14 coupled to a piston head assembly comprising a washer 30, pair of shims 28 and 29, piston head 22 and coupling device configured to secure the piston head assembly to the shaft (illustrated as a nut and flush washer coupled to a threaded end of the shaft). The illustrated assembly is similar to other figures described herein and illustrates how the assembly appears in an assembled mode. Of note, the illustrated piston head is acircular in shape and the assembly includes a plurality of layered shims.

The illustrated acircular piston head 22 is coupled to an end of a piston rod 14 and is configured to be disposed within a cylindrical housing of a shock absorber. The acircular piston head 22 includes a plurality of substantially flat surfaces (flats) 40 disposed on sides of the piston head 22. The illustrated flats form are eight in number and form a generalized octagon shape with arcuate spacing at the vertex between each flat. The number of flats, the length of each flat, and the arc length of each arcuate spacing may be adjusted at the creation of the piston head to create gaps of a desired shape and size. Further, a plurality of piston heads having various geometries may be used to provide variable tuning of performance, such as but not limited to refitting an RC racer between different events at different tracks requiring different performance characteristics.

The arcuate spacing is generally shaped to match and mate with the interior surface of the cylinder to provide maximum surface area contact at the vertexes, thereby preventing damage to the cylinder that may be caused by pointed vertices.

Based on experimentation performed, it is believed that eight flats are needed to optimize the performance and durability of the acircular piston head configuration. In particular, using eight flats promotes great stability of the head as it travels through the cylinder and provides sufficient gap sizing and number to permit appropriate fluid flow during operation when used with smaller vehicles common to radio control vehicles. It is envisioned that acircular designs that are not generally octagonal as illustrated may be utilized, including but not limited to designs that have anywhere from 1-100 flats (or more) of varying sizes and positions, one or more “flats” that are not flat but instead are curved and/or irregular in shape (cutouts, gouges, inset curves, etc.), and/or shapes that may be more simply described as elliptical, ovid, or otherwise not matching the circular profile of the cylindrical housing. Wherein a housing is not cylindrical, acircular means having a profile that does not match the profile of the housing and leaves gaps between the piston head and the inner wall of the housing in one or more regions while being in substantial contact with the inner wall of the housing along one or more regions.

The illustrated flats form bypass gaps between the piston head and the cylindrical housing. The bypass gaps are configured to allow fluid within the cylindrical housing of the shock absorber to pass therethrough, functioning in a manner similar to the bypass apertures 26 of FIGS. 2-7, except that no matching apertures are needed in the shims illustrated in FIGS. 8 and 9 since those shims do not extend over the region of the gaps. Accordingly, the flats permit bilateral fluid flow across the outer surface of the piston head and do not substantially interfere with the operation of the valve(s).

The acircular piston head 22 includes a plurality of spaced arcuate edges 42 sized to come in contact with an interior surface of the cylindrical housing. The spaced arcuate edges in combination with the plurality of substantially flat surfaces are configured to limit piston lock by allowing fluid to pass by the acircular piston head in a fluid, continuous and smooth compression or rebound stroke. As illustrated in FIG. 5, the acircular piston head 22 is octagon shaped. The octagon shape is designed to fit within the cylindrical housing and enable fluid to pass between the acircular piston head 22 and the interior surface of the cylindrical housing during a compression stroke and a rebound stroke.

The acircular piston head 22 includes a plurality of bypass valves 24 disposed through the piston head 22 in an angularly asymmetrical configuration. The acircular piston head includes a plurality of bypass valves formed by cooperative operation of a shim 28 coupled against the bypass apertures and braced against a radial fulcrum member 30, such that fluid is permitted to flow through the bypass valves in a first direction, such as a compression stroke; and be restricted in a second direction, such as a rebound stroke. The shim is configured to fold about a single fold axis when flow is permitted because of the radial asymmetry of the bypass valves. The color of a shim corresponds to a performance characteristic of the shim. The color of a shim corresponds to a thickness of the shim according to a color coding schema. As illustrated in FIG. 5, the acircular piston head includes a plurality of shims coupled against the bypass apertures and braced against a radial fulcrum member configured to further restrict or limit the amount of fluid able to flow therethrough during a compression stroke 50 or a rebound stroke 60 of the shock absorber.

The acircular piston head 22 includes a stop-washer 30 coupled against the shim 28, opposite the piston head 22. The stop-washer 30 includes a flange extending outwardly therefrom, that partially restrict bending of the shim by acting as a fulcrum during a compression stroke or a rebound stroke of the shock absorber. The acircular piston head 22 includes a coupling device 70 configured to couple the piston head assembly to the shaft thereby securing the acircular piston head 22, washer 30 and the shims 28 and 29 to the piston rod 14.

The illustrated assembly includes a plurality of stacked/layered shims 28 and 29 that are sandwiched between the stop-washer 30 and the piston head 22. The shims 28 and 29 are of different radiuses and together provide different performance characteristics from those provided singly. Not shown in the illustrations, the shims may be of different colors to indicate one or more differences in characteristics between the shims.

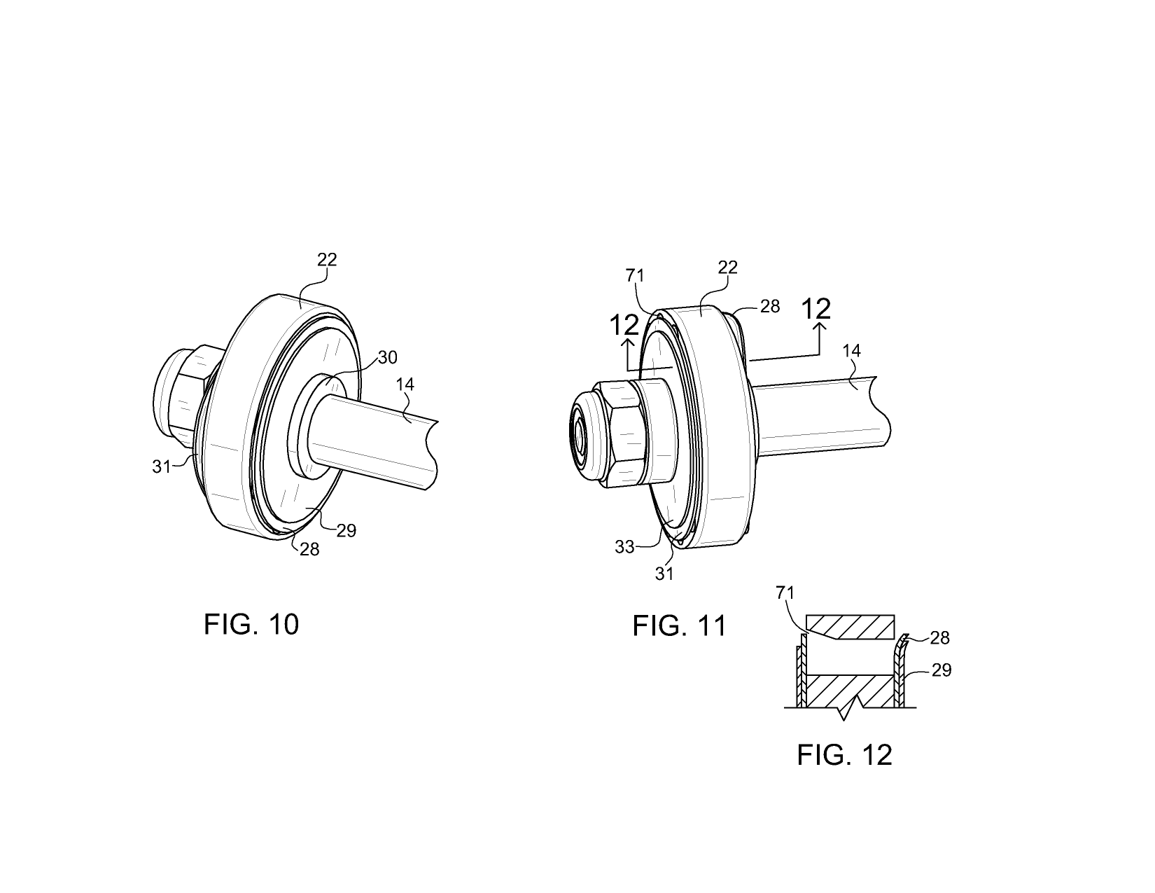

FIGS. 10-11 illustrate back and front perspective views of a piston head assembly and shaft of a shock absorber, according to one embodiment of the invention. FIG. 12 is a cross-sectional view of a portion of FIG. 11. There is shown a shaft 14 coupled to a piston head assembly comprising a washer 30, pair of shims 28 and 29, a piston head 22, a second pair of shims 31 and 33, and coupling device configured to secure the piston head assembly to the shaft (illustrated as a nut and flush washer coupled to a threaded end of the shaft). The illustrated assembly is similar to other figures described herein and illustrates how the assembly appears in an assembled mode. Of note, the illustrated piston head includes a second pair of shims (front shims) disposed on an opposite side of the piston head from the first pair of shims (back shims) and also includes apertures that are not fully covered by the shims.

In operation, the partially covered apertures 71 permit restricted fluid flow therein according to the exposed area of the aperture and only during strokes that are in the same direction as the partially exposed aperture. The illustrated partially covered aperture 71 is formed by an enlarged aperture opening at one side of the piston head and matching inner shims bracketing the aperture, such that on the front side there is a partially covered aperture 71 and on the other side the aperture is only opened during a compression stroke (see the flexed shims 28 and 29 of FIG. 12) and is otherwise fully closed.

Such partially covered apertures 71 may exist on either or both sides of the piston head. Further, partially covered apertures may be either fully covered, partially covered, or fully uncovered on an opposite side of the piston head as desired. Such apertures may be distributed in any manner and such combinations permit a great variety of tuning of performance characteristics of a shock absorber, as the tunable variables include those already described herein plus an additional set of shims (front shims) and varying sizes and positions of partially covered apertures. Further, such features are compatible with acircular piston heads and therefore may be used therewith as desired.

The following are non-limiting exemplary statements of the invention:

### STATEMENTS OF INVENTION

1. A shock absorber comprising a piston head coupled to an end of a piston rod and disposed within a cylindrical housing of a shock absorber, including a plurality of substantially flat surfaces disposed on sides of the piston head that form bypass apertures between the piston head and a cylindrical housing and a plurality of bypass valves disposed through the piston.
2. The shock absorber of claim 1 wherein the bypass valves are formed by cooperative operation of a shim coupled against apertures through the piston head and braced against a radial fulcrum member such that fluid is permitted to flow through the piston head in a first direction and restricted in a second direction and wherein the shim folds about a single fold axis when flow is permitted because of radial asymmetry of the bypass valves.
3. The shock absorber of claim 1 or 2, wherein the plurality of bypass valves are disposed angularly opposite to each other.
4. The shock absorber of any preceding claim, wherein the color of a shim corresponds to a performance characteristic of the shim.
5. The shock absorber of any preceding claim, wherein the color of a shim corresponds to a thickness of the shim according to a color coding scheme.
6. The shock absorber of any preceding claim, further comprising a stop-washer coupled against the shim opposite the piston head and including a flange extending outwardly therefrom that partially restricts bending of the shim by acting as a fulcrum during bending of the same.
7. The shock absorber of any preceding claim wherein the piston head has an acircular cross section.
8. The shock absorber of claim 7 wherein the piston head has an octagonal cross section.
9. The shock absorber of either of claim 7 or 8, wherein the piston head includes a plurality of spaced arcuate edges sized to come in contact with an interior surface of the cylindrical housing.
10. The shock absorber of any preceding claim wherein the shock absorber is fluid-filled and configured to mount within a remote control vehicle.
11. The shock absorber of claim 10 wherein the cylindrical housing is configured to store the fluid and is provided with a top aperture.
12. The shock absorber of any preceding claim wherein the piston rod includes an upper mounting structure configured to extend through the top aperture of the housing.
13. The shock absorber of any preceding claim wherein the sides of the piston head are provided with a plurality of substantially flat surfaces that form the bypass apertures between the piston head and the cylindrical housing.
14. The shock absorber of any preceding claim further comprising a radial fulcrum member coupled against a shim.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate specific combinations of described features, it is understood that the features described herein may be combined in any reasonable manner.

Additionally, although the figures illustrate specific relative sizes and shapes, that other relative sizes and shapes are contemplated herein, such as but not limited to acircular shims and acircular stop-washers.

Finally, it is envisioned that the components of the device may be constructed of a variety of materials, including but not limited to plastics, metals, ceramics, woven fibers, wood, rubbers, composites, and the like and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A fluid-filled shock absorber configured to mount within a remote control vehicle, comprising:
a) a cylindrical housing configured to store a fluid therein including a top aperture;
b) a piston rod including an upper mounting structure configured to extend through the top aperture of the housing;
c) an acircular piston head coupled to an end of the piston rod and disposed within the cylindrical housing, including:
c1) a plurality of substantially flat surfaces disposed on sides of the piston head that form bypass gaps between the piston head and the cylindrical housing; and
c2) a plurality of bypass apertures disposed through the piston head in a angularly asymmetrical configuration; and
d) a plurality of bypass valves formed by cooperative operation of a shim coupled against the bypass apertures and braced against a radial fulcrum member such that fluid is permitted to flow through the bypass valves in a first direction and restricted in a second direction and wherein the shim folds about a single fold axis when flow is permitted because of the radial asymmetry of the bypass valves.

2. The shock absorber of claim 1, wherein the acircular piston head includes a plurality of spaced arcuate edges sized to come in contact with an interior surface of the cylindrical housing.

3. The shock absorber of claim 1, wherein the plurality of bypass valves are disposed in a mirrored configuration.

4. The shock absorber of claim 1, wherein the acircular piston head is generally octagon shaped.

5. The shock absorber of claim 1, further comprising a lower mounting structure coupled to the cylindrical housing, opposite of the upper mounting structure, and configured to couple to a mounting bracket of a remote control vehicle.

6. The shock absorber of claim 1, wherein the color of a shim corresponds to a performance characteristic of the shim.

7. The shock absorber of claim 6, wherein the color of a shim corresponds to a thickness of the shim according to a color coding schema.

8. The shock absorber of claim 1, wherein the radial fulcrum member is a stop-washer coupled against the shim opposite the piston head and including a flange extending outwardly therefrom that partially restricts bending of the shim by acting as a fulcrum during bending of the same.

9. An octagon-shaped piston head coupled to an end of a piston rod and disposed within a cylindrical housing of a shock absorber, including a plurality of substantially flat surfaces disposed on sides of the piston head that form bypass gaps between the piston head and a cylindrical housing and a plurality of bypass apertures disposed through the piston.

10. The octagon-shaped piston head of claim 9, further comprising a plurality of bypass valves formed by cooperative operation of a shim, coupled against the bypass apertures, such that fluid is permitted to flow through the bypass valves in a first direction and restricted in a second direction; and wherein the shim folds about a single fold axis when flow is permitted because of the radial asymmetry of the bypass valves.

11. The octagon-shaped piston head of claim 10, wherein the plurality of bypass valves are disposed in a mirrored configuration.

12. The octagon-shaped piston head of claim 11, wherein the color of a shim corresponds to a performance characteristic of the shim.

13. The octagon-shaped piston head of claim 12, wherein the color of a shim corresponds to a thickness of the shim according to a color coding schema.

14. The octagon-shaped piston head of claim 13, further comprising a radial fulcrum member coupled against the shim opposite the piston head and including a flange extending outwardly therefrom that partially restricts bending of the shim by acting as a fulcrum during bending of the same.

15. A shock absorber, including a plurality of bypass valves disposed on a piston head, wherein the bypass valves are formed by cooperative operation of a shim coupled against a plurality of bypass apertures that are disposed about the piston head in a radial asymmetric pattern such that fluid is permitted to flow through the bypass valves in a first direction and restricted in a second direction and wherein the shim folds about a single fold axis when flow is permitted because of the radial asymmetry of the bypass valves.

16. The shock absorber of claim 15, further comprising a radial fulcrum member coupled against the shim opposite the piston head and including a flange extending outwardly therefrom that partially restricts bending of the shim by acting as a fulcrum during bending of the same.

17. The shock absorber of claim 16, wherein the color of a shim corresponds to a performance characteristic of the shim.

18. The shock absorber of claim 17, wherein the color of a shim corresponds to a thickness of the shim according to a color coding schema.

19. The shock absorber of claim 18, wherein the piston head is an acircular piston head coupled to an end of a piston rod and disposed within a cylindrical housing, including a plurality of substantially flat surfaces disposed on sides of the piston head that form bypass gaps between the piston head and the cylindrical housing.
